(19) United States
(12) Patent Application Publication
(10) Pub. No.: US 2013/0110830 A1
(43) Pub. Date: May 2, 2013

(54) RANKING OF ENTITY PROPERTIES AND RELATIONSHIPS

(71) Applicant: Viswanath Vadlamani, Sammamish, WA (US)

(72) Inventor: Viswanath Vadlamani, Sammamish, WA (US)

(73) Assignee: MICROSOFT CORPORATION, Redmond, WA (US)

(21) Appl. No.: 13/285,002

(22) Filed: Oct. 31, 2011

(51) Int. Cl. G06F 17/30

(52) U.S. Cl. 707/730; 707/723; 707/728; 707/E17.014

(57) ABSTRACT

An entity ranking system is described herein that provides an input signal of ranked attributes between a data source and an entity viewing application. By providing an input signal of ranked attributes the data source can influence the manner in which these applications consume the properties and relationships of these entities. This allows presentation of new information in a “most relevant first” manner and provides a cut-off point in cases of limited space. The system looks across the spectrum of property types and values for a given entity type, identifies the diversity of each attribute/value, and computes a rank based on multiple distance measures. Thus, the system provides ranking information from a data source to describe how to rank entity properties so that applications can be written more generically to deal with many types of entities while still displaying the most relevant entity information.

### BACKGROUND

For the purpose of this specification, an entity refers to a concept, thing, or event. For example, Seattle Wash., Tom Hanks, MICROSOFT™ Corporation, the Gulf War, and Big Bang Theory are all examples of entities. Entities may have properties. A property reflects any aspect of or information related to the given entity. Examples of properties of entities include a person's birth date and name, a place's geographic coordinates, and a company's revenue. Entities may also share relationships with other entities. For example, entity “Tom Hanks” has a relationship “spouse” with another entity “Rita Wilson”, entity “Tom Hanks” has relationship “acted in” with entity “Saving Private Ryan”, and entity “Microsoft Corporation” has relationship “CEO” with entity “Steve Ballmer”. As a rule of thumb, the properties of an entity represent aspects in the form of strings, literals, or other information while relationships of an entity involve other entities.

It is often useful to rank entity properties and relationships. Consider the information provided by Wikipedia for the entity/movie, “Saving Private Ryan”. That entry lists a director, four producers, a writer, four top-billed stars, a distributor, a release date, a running time, a country, a language, a budget, and a gross revenue. Each of these is a property of the entity, some with multiple attribute values. In some situations or applications, there may only be space to display five properties for the entity “Saving Private Ryan” instead of all of them. Which five will be chosen is the function of ranking of properties and relationships. Several real-world applications have limited display real estate in which to display information (e.g., mobile phones, web page sidebars, kiosks, and so on). It is not generally feasible to display all the attributes that an entity data source may provide. In addition, people/information consumers have limited attention spans, so that it is often helpful to display information structured in a way that conveys the most relevant information in limited space and time.

An entity is described by sum of its properties, relationships, and their contexts. Currently, the order in which these attributes are displayed is often left to the application that receives this information. For example, a mobile application for displaying movie lists may hard code which movie attributes it will display and where/how it will display them. In many cases, the data source may want to have some influence upon the data, but this is not possible or is difficult in current systems. For example, a data source may want to surface new or unique information about an entity. Dependency on the application for ranking also implies that new entity types cannot be displayed with any ranking until an application developer takes the time to build a custom application to do so. Thus, new types of information may build up in data sources for a period before applications for effectively viewing the information are available. It is common to see new websites or other applications appear well after there is a need for viewing a particular type of information. For example, the Internet Movie Database (IMDB) website provides movie information that was available long before that site's existence but the information was difficult to view or access in any structured manner.

### SUMMARY

An entity ranking system is described herein that provides an input signal of ranked attributes between a data source and an entity viewing application. By providing an input signal of ranked attributes, the data source can influence the manner in which these applications consume the properties and relationships of these entities. The more effective ranking provided by the system allows presentation of new information in a “most relevant first” manner and can also provide a cut-off point in cases of limited space. The entity ranking system looks across the spectrum of property types and their values for a given entity type in a universe of types, identifies the diversity of each attribute/value, and computes a rank based on multiple distance measures. Most search engines today index information in the form of one or more keywords associated with a uniform resource locator (URL) where content related to the keywords can be found. A more useful way to index information is to form a list of one or more properties associated with an entity. Entities will form the basis of more useful search results, and ranking entity properties and relationships is an integral part of providing an entity-based search experience. Thus, the entity ranking system provides ranking information from a data source to describe how to rank entity properties so that applications can be written more generically to deal with many types of entities while still displaying the most relevant entity information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the entity ranking system, in one embodiment.

FIG. 2 is a flow diagram that illustrates processing of the entity ranking system to process a query for ranked properties associated with a particular entity, in one embodiment.

FIG. 3 is a flow diagram that illustrates processing of the entity ranking system to determine a ranking score for properties of a given entity, in one embodiment.

### DETAILED DESCRIPTION

An entity ranking system is described herein that provides an input signal of ranked attributes between a data source and an entity viewing application. By providing an input signal of ranked attributes, the data source can influence the manner in which these applications consume the properties and relationships of these entities. The more effective ranking provided by the system allows presentation of new information in a “most relevant first” manner and can also provide a cut-off point in cases of limited space. The entity ranking system looks across the spectrum of property types and their values for a given entity type in a universe of types, identifies the diversity of each attribute/value, and computes a rank based on multiple distance measures. One application of entity ranking is in the field of search engines. A search engine can be thought of as a generic entity display application. It is generic in the sense that the search engine may be called on by a user to find information related to movies, books, restaurants, tasks, topics, news, or any other entity type. It is not feasible for the search engine to know how to display relevant information specifically for each of these types, so general mechanisms are often used, such as keyword analysis or asking web page authors to provide content summaries.

Most search engines today index information in the form of one or more keywords associated with a uniform resource locator (URL) where content related to the keywords can be found. A more useful way to index information is to form a list of one or more properties associated with an entity. Upon searching for restaurants, for example, a user would rather receive a list of restaurants and relevant information (e.g., the menu, hours, address, or phone number) rather than a list of links to documents about restaurants, such as what is provided today. Entities will form the basis of more useful search results, and ranking entity properties and relationships is an integral part of providing an entity-based search experience. Thus, the entity ranking system provides ranking information from a data source to describe how to rank entity properties so that applications can be written more generically to deal with many types of entities while still displaying the most relevant entity information.

Many signals represent relevance of information conveyed by a property or relationship with respect to a given entity. The entity ranking system combines these signals to yield overall ranking scores. The combination itself can be customized to reflect different application goals. One category of signals includes those signals that are taxonomy based. A taxonomy classifies information specific to a particular field or subject area. Taxonomy-based ranking scores are useful because they allow field experts to capture their expertise in a score and influence the final ranking. For example, film experts may want to indicate that “directed by” and “starring” are the two most relevant attributes for entities of type “film”. Such scores mimic the behavior of traditional websites where an editor handpicks the attributes to show for a given entity.

Another way of capturing the relative importance of properties and relationships of entities is by looking at search engine query logs and finding the frequency of occurrence for patterns of the form [ENTITY] [PROPERTY/RELATIONSHIP NAME] or [PROPERTY/RELATIONSHIP NAME] [ENTITY], and the like. For example, if a lot of people search for “Capital of England”, “Capital of France”, “Population of Mexico”, “Population of Russia”, and so forth then one can conclude that “Capital” and “Population” are more relevant attributes for entities of type “Country” than other properties like “Area” or “HDI” (human development index), which have low search frequency.

Another signal that can be used for inferring the relative importance of a relationship is the importance of an entity to which another entity is being related. For example, for entity “Michelle Obama” the relationship “spouse” which relates to “Barack Obama” is a lot more relevant than the “spouse” relationship for entity say “Tom Hanks”. This signal allows the system to rank entities dynamically and show different properties for different entities potentially belonging to same “type”, which are nevertheless reflective of a property's importance for each specific entity.

In some embodiments, news can influence entity ranking. Relative importance of relationships can be extended to incorporate news items and dynamic ranking of relationships depending on latest news. For example, for entity “Tiger Woods”, the relationship “last championship won” may be more relevant during the golfing season while “spouse” was more relevant during the 2010 scandal.

In cases where a query is present and the user specifically asks for a certain set of attributes, the overall ranking of attributes can be influenced by their relevance to the query. For example, for a query “Saving Private Ryan statistics”, properties such as “Budget”, “Running Time”, “Release Date”, “Revenue”, and so forth would be ranked higher than “Directed By”, “Starring”, and the like. The query keyword “statistics” signals a particular type of information that the searcher is looking for, and the system uses this information to provide a ranking specific to the input query.

Several signals, some of which have been discussed above, can be combined to compute the final ranking score. A straight-forward way of doing so is a linear-weighted combination of scores for each signal:

Rᵢ=ΣₛWₛ×Sₛⁱ

Where Rᵢ denotes the ranking score for property/relationship ‘i’ while Wₛ denotes the weight of signal type ‘s’ and Sₛⁱ denotes the score of property/relationship ‘i’ for signal ‘s’. The weighting scheme W allows the system to have different weights for different application scenarios. For example, for the search-engine application scenario the relevance and news-based importance metrics are more useful while in portal application scenarios the taxonomy-based importance metrics are more useful.

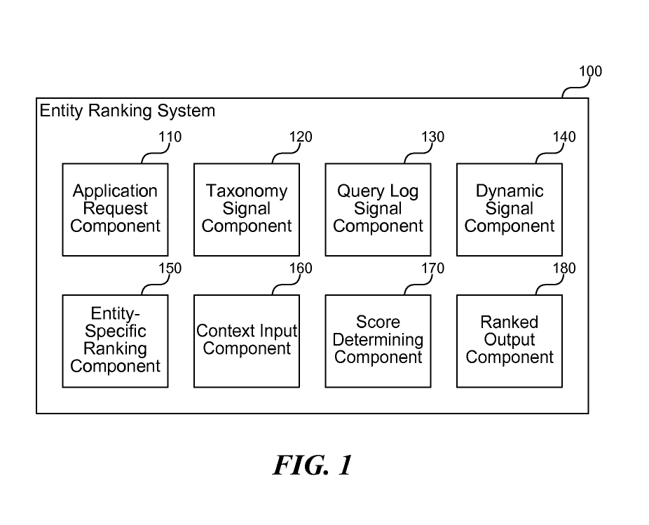

FIG. 1 is a block diagram that illustrates components of the entity ranking system, in one embodiment. The system 100 includes an application request component 110, a taxonomy signal component 120, a query log signal component 130, a dynamic signal component 140, an entity-specific ranking component 150, a context input component 160, a score determining component 170, and a ranked output component 180. Each of these components is described in further detail herein.

The application request component 110 receives requests from one or more applications to return entities and ranked lists of their properties. The component 110 may receive requests via a web page, web service, application-programming interface (API), or any other interface for receiving requests to retrieve data. A request may include context information, such as a purpose of the request, one or more keywords related to the request, weights or relative relevance of various signals that affect the ranking, and so on. A request may also identify a specific entity or type of entity for which to return properties in response to the request. The application may include a search engine, entity-viewing application, or any other type of application that uses any type of entity or entity data. The application may also provide limitations in the request, such as a limit of properties that the application can display.

The taxonomy signal component 120 provides a ranking signal based on a taxonomy related to a specific subject area. Taxonomy based signals may be determined automatically or be provided by one or more editors that classify a subject area. A taxonomy defines which properties of a particular entity type or specific entities are most relevant. The taxonomy may include various contexts, such that different properties are considered most relevant under different conditions or based on different application requirements. A taxonomy signal may be particularly useful for portal types of applications that want to display classified lists of topic areas or entity properties.

The query log signal component 130 provides a ranking signal based on web query logs that indicate how frequently search queries include particular entity properties. The component 130 provides an analysis of past user queries, and may include keyword proximity, keyword frequency, and other factors to provide a ranking signal. For example, if users frequently search for “capital of Italy” then the component 130 may provide a strong signal for the property “capital” in relation to queries for the entity type “country”. The proximity of keywords in the query logs and the frequency of occurrence of such queries provide a hint as to the relative relevance of various properties. In some cases, the system 100 may apply normalization to prevent overemphasis of popular properties. For example, a property like “age” may be common in searches for particular names of people, but may not be as relevant for display in applications as the frequency of searches would indicate. Normalization can adjust for any exceptions.

The dynamic signal component 140 provides a dynamically changing ranking signal that adapts a ranking of entity properties based on recent information. For example, the signal may incorporate news and other fast-changing information to the ranking for an entity. As an example, consider a popular celebrity that has recently passed away. In normal cases, a cause or date of death may not be a highly relevant property related to a person entity, but in the days following a person's death, these properties are very relevant and frequently requested. Thus, the system 100 can rate such properties higher for a period following such events. As another example, scandals or disasters may lead to particular properties being more relevant for a particular entity. For example, the information people requested about Japan changed in 2011 following the tsunami and resulting nuclear reactor damage from the types of information requested previously. This type of information can affect the ranking produced by the system 100.

The entity-specific ranking component 150 provides a ranking signal based on specific entities and exceptional relevance of particular properties for those entities. For example, users are often interested in different information for presidents of the United States than for other people. Whereas a spouse of most people may not be well known, the spouse of presidents is often very relevant and well known. Fame may also change the relevance of information about other people, places, or things. For example, people may request different information about business leaders or places where significant events occur than they do for regular people or places. This component 150 provides a signal that incorporates any exceptions for a specific entity that would suggest a different ranking than the default (that produced by other signals) for the entity.

The context input component 160 receives context information related to a request and provides a ranking signal that indicates relevance of particular entity properties to the request. For example, a request for “movie statistics” indicates that the user is more interested in properties like “gross revenue” and “cost to produce” for a movie than who starred in the movie or what genre the movie belongs to. The request may provide keywords, specific properties of interest, and other information that suggests a different ranking than the system 100 would otherwise produce. The system 100 incorporates this type of information into the ranking process through the context input component 160 to affect the ranking for specific contexts. This makes the resulting ranking highly relevant for the nature of the received request.

The score determining component 170 combines signals to produce a ranking score that ranks properties for an entity. The component 170 may apply a weight to each score and combine the scores in any number of ways. For example, in some embodiments, the component 170 may add each of the weighted scores to produce a linear combination. In some embodiments, the system may leverage a complex algorithm that applies application specific criteria for ranking property relevance. The system 100 may provide an API through which applications can specify weights of particular signals to use, functions to use for combining signals, or other input to affect how the score determining component 170 comes to a final score for ranking entity properties. This allows both the data source and requesting application to influence the way entity properties are ranked, and to set this balance differently for different purposes. For example, a particular application may prefer a certain set of signals for known entity types but may defer more to the data source for new or unknown entity types.

The ranked output component 180 sends a response to the received application request that includes a ranked set of entity properties based on the ranking score. The ranked output component 180 may provide a visual response (e.g., through a web page or mobile application), a programmatic response (e.g., through an API or event interface), or other output consumable by the requesting application. The response may include property values or just a determined ranking of properties. Based on the response, the application may request property data for a certain number of the ranked properties or may display data directly provided in the response. Those of ordinary skill in the art will recognize numerous variations and optimizations based on performance and other goals that do not depart from the scope and purpose of the system 100 described herein.

The computing device on which the entity ranking system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

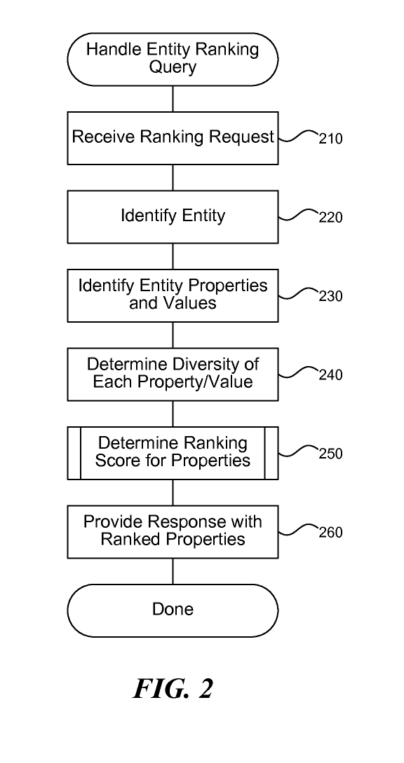

FIG. 2 is a flow diagram that illustrates processing of the entity ranking system to process a query for ranked properties associated with a particular entity, in one embodiment. Beginning in block 210, the system receives a request from an application to rank properties for a specified entity or type of entity. For example, a web application may invoke an API or a web-based data source that stores entity information. The API may receive information such as an entity or type of entity, context information about the request that could affect the resulting ranking, and so forth. For example, the context information may include one or more keywords or entity properties that are particularly relevant to the request. The system may receive requests from a variety of types of applications for a variety of purposes. The applications may include generic applications like search engines, or specific applications like a movie information viewing application that request entity information.

Continuing in block 220, the system identifies the requested entity or type of entity for which ranked property information is requested. The request may name a particular entity (e.g., movie “The Hunt for Red October”) or a type of entity (e.g., movies) for which the application is requesting information. In some cases, the request may not specify the entity itself, but rather information related to the entity (e.g., “the lead actor in Jurassic Park”). This allows users to leverage information they know to connect with the information they seek.

Continuing in block 230, the system identifies properties and property values associated with the specified entity. For example, the system may access a data source associated with the specified entity and enumerate property information stored within the data source. The system includes a data source that may include one or more files, file systems, hard drives, databases, cloud-based storage services, or other facilities for storing data. The data source includes multiple entities and multiple properties for each entity. The system accesses this information to produce a ranking of properties with which to response to the received request.

Continuing in block 240, the system determines a diversity of each identified property and property value. The diversity includes one or more distance measurements that indicate how relevant each property is to the received request. The diversity contributes to a ranking score produced by the system for ranking the entity properties.

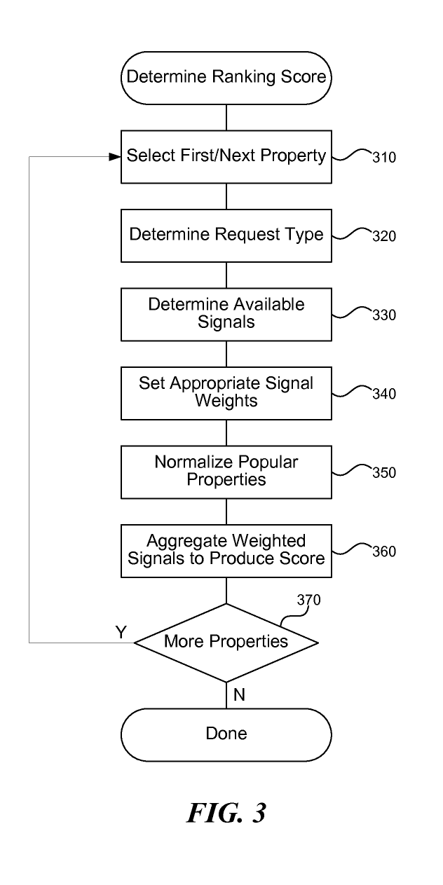

Continuing in block 250, the system determines a ranking score for each property. The ranking score may be determined from a variety of weighted signals that each provide some information related to relevance of a particular property to the current received request. The process of determining a ranking score is described further with references to FIG. 3.

Continuing in block 260, the system provides a response to the received request that includes ranked properties based on the determined ranking score. The ranked properties provide information from the data source to the requesting application that informs the requesting application how to display the entity and which properties may be most relevant to the application. By providing information about the information's purpose to the data source, the application receives information from the data source that the application can use to display relevant entity information, even for entities whose type is not specifically anticipated or programmed for by the application. After block 260, these steps conclude.

FIG. 3 is a flow diagram that illustrates processing of the entity ranking system to determine a ranking score for properties of a given entity, in one embodiment. Beginning in block 310, the system selects a first property of an entity for which to determine a ranking score that indicates the relevance of the property relative to other properties of the entity. The relevance for any particular request may vary and depend on context information specific to the particular request as described herein.

Continuing in block 320, the system determines a request type to determine one or more signal weights for weighting the relevance of various signal types. The type and context of the request affect how different signals are weighted. For example, a request from a portal application to display general information about a type of entity may suggest different signal weights than a query request to retrieve a specific class of information related to an entity. As an example, a request to display a list of movies released in 2010 may suggest the display of different properties (e.g., title, rating, reviews) than a request to display movie statistics (e.g., budget, gross receipts, screens shown).

Continuing in block 330, the system determines multiple available signals that provide ranking information related to properties of the selected entity. Signals may include a variety of types of information, such as taxonomy information, query log information, dynamic information, entity-specific information, information related to the context of the ranking request, and so forth. Different signals may be available for some entities than are available for others. The system determines the signals available for the entity being ranked. For example, experts may have provided a taxonomy that classifies information for one type of entity, but other types of entities may have no available taxonomy.

Continuing in block 340, the system sets signal weights appropriate to a current ranking request, wherein the weights affect the relative impact of each signal on a resulting ranking score. The system may set weights received from a request application, based on preconfigured weights specific to the request's purpose, based on administrator configuration data, or on any other basis. In some cases, an operator of a particular data source may provide and tune weights based on experience of settings that produce a good result. In other cases, the requesting application may rely more heavily on certain signal types and may specify a higher weight for such signals.

Continuing in block 350, the system normalizes signal information for one or more properties to avoid overemphasis of a popular property. Normalization avoids anomalies where a particular signal, such as web query logs, unduly skews the ranking for a particular property of an entity. Normalization accounts for other reasons for popularity of particular properties that do not necessarily pertain to ranking of the properties.

Continuing in block 360, the system aggregates the weighted signals to produce a ranking score. The ranking score combines information from multiple signals to produce a score that indicates how relevant the currently selected property is to other properties of the identified entity. The system may sort properties according to the score to provide a ranked list of properties the requesting application. In some cases, the system caches ranking information to more efficiently handle subsequent requests.

Continuing in decision block 370, if the system determines that more entity properties are available for ranking, then the system loops to block 310 to select the next property of the entity, else the system completes. Although shown occurring serially for ease of illustration, those of ordinary skill in the art will recognize that scores for entity properties may be determined in parallel for more efficient operation of the system or to address other goals of specific implementations of the system. After block 370, these steps conclude.

From the foregoing, it will be appreciated that specific embodiments of the entity ranking system have been described herein for purposes of illustration, but that various modifications may be made without deviating from the spirit and scope of the invention. Accordingly, the invention is not limited except as by the appended claims.

I/we claim:

1. A computer-implemented method to process a query for ranked properties associated with one or more entities, the method comprising:
receiving a request from an application to rank properties for a specified entity or type of entity;
identifying the requested entity or type of entity for which ranked property information is requested;
identifying properties and property values associated with the specified entity;
determining a diversity of each identified property and property value;
determining a ranking score for each property; and
providing a response to the received request that includes ranked properties based on the determined ranking score,
wherein the preceding steps are performed by at least one processor.

2. The method of claim 1 wherein receiving the request comprises invoking an application-programming interface (API) between a web-based application that displays entity information and a web-based data source that stores entity information.

3. The method of claim 1 wherein receiving the request comprises receiving context information related to the request that affects the resulting ranking.

4. The method of claim 1 wherein identifying the request entity comprises receiving an indication identifying a specific entity from a user of the application.

5. The method of claim 1 wherein identifying properties comprises accessing a data source associated with the specified entity and enumerating property information stored within the data source.

6. The method of claim 1 wherein determining the diversity comprises performing one or more distance measurements that indicate how relevant each property is to the received request.

7. The method of claim 1 wherein determining the diversity contributes to a ranking score produced by the system for ranking the entity properties.

8. The method of claim 1 wherein determining the diversity applies one or more ranking signals that provide an indication of the relevance of each property to the received request.

9. The method of claim 1 wherein determining the ranking score comprises aggregating multiple weighted ranking signals to produce an aggregate ranking score reflective of the relative relevance of each property to the received request.

10. The method of claim 1 wherein the ranked properties in the response provide information from a data source to a requesting application that informs the requesting application how to display the entity and which properties are most relevant to the application.

11. A computer system for ranking of entity properties and relationships, the system comprising:
a processor and memory configured to execute software instructions embodied within the following components;
an application request component that receives requests from one or more applications to return entities and ranked lists of entity properties;
a taxonomy signal component that provides a ranking signal based on a taxonomy related to a specific subject area;
a query log signal component that provides a ranking signal based on web query logs that indicate how frequently search queries include particular entity properties;
a dynamic signal component that provides a dynamically changing ranking signal that adapts a ranking of entity properties based on recent information;
an entity-specific ranking component that provides a ranking signal based on specific entities and exceptional relevance of particular properties for those entities;
a context input component that receives context information related to a request and provides a ranking signal that indicates relevance of particular entity properties to the request;
a score determining component that combines signals to produce a ranking score that ranks properties for an entity; and
a ranked output component that sends a response to the received application request that includes a ranked set of entity properties based on the ranking score.

12. The system of claim 11 wherein the application request component receives requests via a web page, web service, or application-programming interface (API), wherein the request includes context information related to the request.

13. The system of claim 11 wherein the taxonomy signal component automatically classifies entity information to produce a taxonomy of properties for at least one entity.

14. The system of claim 11 wherein the taxonomy signal component receives input from an editor that classifies information for entities in a subject area.

15. The system of claim 11 wherein the query log signal component provides an analysis of past user queries, including keyword proximity and keyword frequency, to determine a relative importance of properties of an entity.

16. The system of claim 11 wherein the query log signal component applies normalization to prevent overemphasis of popular properties.

17. The system of claim 11 wherein the dynamic signal component provides a signal based on news related to an entity.

18. The system of claim 11 wherein the context input component receives one or more keywords in a request and determines one or more properties of an entity related to the received keywords.

19. The system of claim 11 wherein the score determining component performs a weighted linear combination of signals to produce the ranking score.

20. A computer-readable storage medium comprising instructions for controlling a computer system to determine a ranking score for properties of a given entity, wherein the instructions, upon execution, cause a processor to perform actions comprising:
selecting a first property of an entity for which to determine a ranking score that indicates the relevance of the property relative to other properties of the entity;
determining a request type to determine one or more signal weights for weighting the relevance of various signal types;
determining multiple available signals that provide ranking information related to properties of the selected entity;
setting signal weights appropriate to a current ranking request, wherein the weights affect the relative impact of each signal on a resulting ranking score;
aggregating the weighted signals to produce a ranking score;
repeating the preceding steps for each property of the entity and ranking all of the properties of the entity by the determined ranking score for each property.
